(19) United States
(12) Patent Application Publication
(10) Pub. No.: US 2020/0065732 A1
(43) Pub. Date: Feb. 27, 2020

(54) METHODS, APPARATUSES AND COMPUTER PROGRAM PRODUCTS FOR MANAGING REQUISITIONS VIA USER INTERFACES

(71) Applicant: APC Workforce Solutions, LLC D/B/A ZeroChaos, Orlando, FL (US)

(72) Inventors: Nancy Daniel Hecker, Orlando, FL (US); Mark Woytowicz Wyatt, Santa Rosa, CA (US)

(21) Appl. No.: 16/549,900

(22) Filed: Aug. 23, 2019

Related U.S. Application Data
(60) Provisional application No. 62/722,738, filed on Aug. 24, 2018.

(51) Int. Cl. G06Q 10/06; G06F 9/451; G06Q 30/04

(52) U.S. Cl. CPC G06Q 10/06313; G06Q 30/04; G06F 9/451

(57) ABSTRACT

Methods, and apparatuses are provided for managing requisitions via user interfaces. A method may include generating, via a user interface, a requisition for a product/service. The requisition includes a milestone(s) and/or item(s) of worker data. The method further includes detecting input from a service provider and/or manager. The input includes updating the milestone(s) and/or item(s) of worker data. The method further includes receiving, via the user interface, input from the service provider or manager denoting an agreement to the milestone(s) and item(s) of worker data. The method further includes, responsive to an agreement to the milestone(s) and item(s) of worker data, receiving, via the user interface, a request from the manager to lock the requisition. The method further includes, responsive to locking the requisition, generating an engagement based on the requisition and invoicing, via the user interface, a client for work provided by the service provider according to the milestone(s).

### CROSS-REFERENCE TO RELATED APPLICATIONS

This application is a continuation of and claims the benefit of U.S. Provisional Patent Application No. 62/722,738, filed on Aug. 24, 2018, entitled “Methods, Apparatuses And Computer Program Products For Managing Requisitions,” the contents of which are hereby incorporated by reference herein in its entirety.

### TECHNICAL FIELD

Exemplary embodiments of the present disclosure relate generally to methods, apparatuses and computer program products for improving techniques of managing requisitions via user interfaces.

### BACKGROUND

In order to supplement an existing work force, businesses may hire one or more independent contractors to assist with professional service needs of a business. Professional services can involve using specialists to support the business by providing tax advice, accounting assistance, information technology (IT) services assistance, providing management advice, etc.

A statement of work (SOW) is used by the business to define the work to be done and needs to be fulfilled by the independent contractors. The SOW can also indicate a particular contractor/vendor and define project-specific activities, deliverables and timelines for a vendor/service provider providing services to the business. The SOW typically also includes detailed requirements and pricing, invoicing with standard regulatory and governance terms and conditions.

### SUMMARY

A method, apparatus and computer program product are therefore provided for providing improved techniques of managing requisitions among various entities as well as configuring options within the requisitions and setting access rights of the entities within the requisitions, as described more fully below.

The exemplary embodiments may also generate user interfaces to enable selection of customized settings to tailor workflows associated with the requisitions according to the desires of customers.

In one example embodiment, an apparatus for managing requisitions via user interfaces is provided. The apparatus may include a processor and a memory including computer-executable instructions. The memory and the computer-executable instructions are configured to, with the processor, cause the apparatus to at least perform operations including generate, via a user interface, a requisition for a product or service, wherein the requisition includes one or more milestones and/or one or more items of worker data. The memory and computer-executable instructions are also configured to detect input from a service provider and/or a manager, wherein the input comprises updating the one or more milestones and/or one or more items of worker data of the requisition. The memory and computer-executable instructions are also configured to receive, via the user interface, an input from the service provider or manager denoting an agreement to the one or more milestones and one or more items of worker data associated with the requisition. The memory and computer-executable instructions are also configured to, in response to an agreement to the one or more milestones and one or more items of worker data associated with the requisition, receive, via the user interface, a request from the manager to lock the requisition. The memory and computer-executable instructions are also configured to, in response to locking the requisition, generate an engagement based on the requisition. The memory and computer-executable instructions are also configured to invoice, via the user interface, a client for work provided by the service provider according to the one or more milestones.

In another example embodiment, a method for managing requisitions via user interfaces is provided. The method may include generating, via a user interface, a requisition for a product or service, wherein the requisition includes one or more milestones and/or one or more items of worker data. The method may further include detecting, via a processor, input from a service provider and/or a manager, wherein the input comprises updating the one or more milestones and/or one or more items of worker data of the requisition. The method may further include receiving, via the user interface, an input from the service provider or manager denoting an agreement to the one or more milestones and one or more items of worker data associated with the requisition. The method may further include, in response to an agreement to the one or more milestones and one or more items of worker data associated with the requisition, receive, via the user interface, a request from the manager to lock the requisition. The method may further include, in response to locking the requisition, generating an engagement based on the requisition. The method may further include invoicing, via the user interface, a client for work provided by the service provider according to the one or more milestones.

In another example embodiment, a computer program product for managing requisitions via user interfaces is provided. The computer program product includes at least one computer-readable storage medium having computer-executable program code instructions stored therein. The computer-executable program code instructions may include program code instructions configured to generate, via a user interface, a requisition for a product or service, wherein the requisition includes one or more milestones and/or one or more items of worker data. The computer program product may further include program code instructions configured to detect input from a service provider and/or a manager, wherein the input comprises updating the one or more milestones and/or one or more items of worker data of the requisition. The computer program product may further include program code instructions configured to receive, via the user interface, an input from the service provider or manager denoting an agreement to the one or more milestones and one or more items of worker data associated with the requisition. The computer program product may further include program code instructions configured to, in response to an agreement to the one or more milestones and one or more items of worker data associated with the requisition, receive, via the user interface, a request from the manager to lock the requisition. The computer program product may further include program code instructions configured to, in response to locking the requisition, generate an engagement based on the requisition. The computer program product may further include program code instructions configured to invoice, via the user interface, a client for work provided by the service provider according to the one or more milestones.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems.

FIG. 1 is a schematic block diagram of a system according to an exemplary embodiment of the present disclosure;

FIG. 2 is a block diagram illustrating an example computing device;

FIG. 3 is a diagram illustrating an exemplary user interface according to an exemplary embodiment of the present disclosure;

FIG. 4 is a diagram illustrating a table of requisition type settings according to an exemplary embodiment of the present disclosure;

FIG. 5 is a diagram illustrating an exemplary user interface according to exemplary embodiments of the present disclosure;

FIG. 6 is a diagram illustrating an exemplary user interface according to exemplary embodiments of the present disclosure;

FIG. 7 is a diagram illustrating an exemplary user interface according to exemplary embodiments of the present disclosure;

FIG. 8 is a diagram illustrating an exemplary user interface according to exemplary embodiments of the present disclosure;

FIG. 9 is a diagram illustrating an exemplary user interface according to exemplary embodiments of the present disclosure;

FIG. 10 is a diagram illustrating an exemplary user interface according to exemplary embodiments of the present disclosure;

FIG. 11 is a diagram illustrating an exemplary user interface according to exemplary embodiments of the present disclosure;

FIG. 12 is a diagram illustrating an exemplary user interface according to exemplary embodiments of the present disclosure; and

FIG. 13 is a flow diagram illustrating a method for managing requisitions according to one or more exemplary embodiments of the present disclosure; and

FIG. 14 is a flow diagram illustrating another example method for managing requisitions via one or more user interfaces according to another exemplary embodiment of the present disclosure.

### DETAILED DESCRIPTION OF ILLUSTRATIVE EMBODIMENTS

Some embodiments of the present disclosure will now be described more fully hereinafter with reference to the accompanying drawings, in which some, but not all embodiments of the present disclosure are shown. Indeed, various embodiments of the present disclosure may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the present disclosure. Moreover, the term “exemplary”, as used herein, is not provided to convey any qualitative assessment, but instead merely to convey an illustration of an example. Thus, use of any such terms should not be taken to limit the spirit and scope of embodiments of the present disclosure.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, a manager(s) may refer to a user (e.g., an individual) that oversees and manages one or more requisitions that may, but need not, be associated with responses to Requests for Proposal (RFP), Requests for Information (RFI) or the like pertaining to products and/or services that may be requested by a customer(s)/client(s).

As referred to herein, a service provider(s) may refer to an entity (e.g., a company, organization, institution, individual, etc.) that submits, to the manager(s), a response to a requisition(s) that may, but need not, be associated with an RFP or RFI.

As referred to herein, a managed service provider (MSP) may refer to an outsourced agency that manages the non-employee workforce (e.g., independent contractors, temporary workers, companies that provide services via a SOW) for a client.

It is to be understood that the methods and systems described herein are not limited to specific methods, specific components, or to particular implementations. It is also to be understood that the terminology used herein is for the purpose of describing particular embodiments only and is not intended to be limiting.

Often, a contractor, vendor, independent contractor or service provider (hereinafter service provider) is not involved when defining the SOW leading to requisitions because input is only provided by the business, i.e., a one-way requisition. Because the service provider is not involved when defining the SOW or the service provider's involvement takes place outside of a vendor management system (VMS), conflicts can arise between the business and service provider due to ambiguities or vagueness (e.g., milestones and invoicing) in the SOW or different interpretations of the SOW due to previous engagements between the business and the service provider.

Accordingly, efficiencies can be obtained when the service provider and business can define milestones and milestone line items, as well as negotiate other aspects of the SOW (e.g., how and when invoicing will occur and workers). Having a mutual understanding between the business and the service provider before work under the SOW starts leads to more efficient completion of the work under the SOW because the terms have been addressed bilaterally and reduces potential conflict between the business and service provider because both parties have an understanding of desired deliverables, invoicing, and payment. In addition, having negotiations take place in a centralized location allows each party to the SOW to quickly understand a current state of negotiations and/or the SOW, as well as any proposed or agreed upon updates to the SOW, i.e., a historical record of which party made changes to the SOW, when the changes occurred and a time frame between stages of the SOW being completed. Accordingly, a system that allows convenient review of the SOW for parties to the SOW and records every action and change during negotiations of terms related to a SOW by the business and service provider, as well as subsequent changes/updates to performance of work under the SOW is beneficial.

Various exemplary embodiments of the present invention relate generally to automating managing of requisitions via one or more graphical user interfaces. Applicant has identified that some existing systems utilize techniques that involve generation of one-sided requisitions, for services, which are created by an entity (e.g., an organization), but which lack robustness in the system for other entities (e.g., service providers, managing entities, etc.) to electronically propose changes within the requisition, in real-time, prior to approval of the requisition (or subsequent to the approval of the requisition). The inability to electronically tailor the requisition itself bilaterally in real-time may cause communication devices in the system to inefficiently consume processing resources (e.g., processing capacity) by generating communications to the creator (e.g., an organization) of the requisition outside of the electronic requisition process itself to propose requisition changes, updates, etc. Storing these proposed requisition changes/updates may also constrain memory of storage devices. Additionally, sending these proposed requisition changes/updates in communications (outside of the requisition process) across a network may inefficiently constrain network bandwidth. Applicant has identified that conserving processing resources and memory space as well as minimizing network bandwidth is important to improving any implementation of an automated management of requisitions via graphical user interfaces.

Example embodiments may utilize one or more graphical requisition user interfaces that allow bilateral proposals (e.g., submissions of updated milestone data, worker data, proposed cost for completion of a product or service, etc.) among entities associated with a requisition within the graphical requisition user interfaces themselves in real-time. By using these graphical requisition user interfaces, to create tailored requisitions as well as to enable proposal of updates regarding requisitions in real-time, within the graphical requisition user interfaces themselves, the exemplary embodiments may conserve processing capacity, memory storage of memory devices and network bandwidth. For instance, the exemplary embodiments may conserve processing capacity, memory storage of memory devices and network bandwidth by minimizing any need to generate and send communications to the creator (e.g., an organization) of the requisitions outside of the electronic requisition process itself to propose requisition changes, updates, etc. since such proposals may be made within the graphical requisition user interfaces of the exemplary embodiments in real-time.

As such, systems structured in accordance with various embodiments of the invention provide specific, technical solutions to technical problems faced by some systems.

### General System Architecture

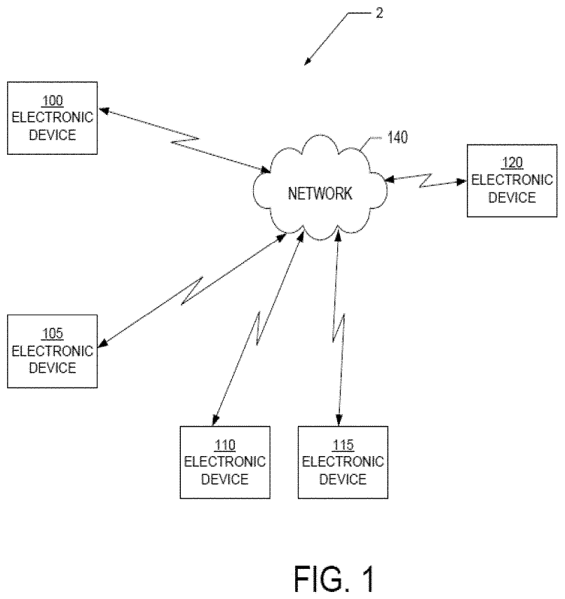

Reference is now made to FIG. 1, which is a block diagram of a system according to exemplary embodiments. As shown in FIG. 1, the system 2 may include one or more communication devices 100, 105, 110, 115, and 120 (e.g., personal computers, laptops, workstations, servers, personal digital assistants, smart devices and the like, etc.) which may communicate with each other over a network 140, such as a wired local area network (LAN) or a wireless local area network (WLAN), a metropolitan network (MAN) and/or a wide area network (WAN) (e.g., the Internet). In this regard, the electronic devices 100, 105, 110, 115 and 120 are capable of receiving data from and transmitting data via network 140.

In one exemplary embodiment, the electronic devices 100, 105, 110, 115, and 120 may be utilized by users of entities to manage one or more requisitions and to configure options for the requisitions, as described more fully below.

It should be pointed out that although FIG. 1 shows five electronic devices 100, 105, 110, 115, and 120 any suitable number of electronic devices 100, 105, 110, 115, and 120 may be part of the system of FIG. 1 without departing from the spirit and scope of the present disclosure.

### Computing Device

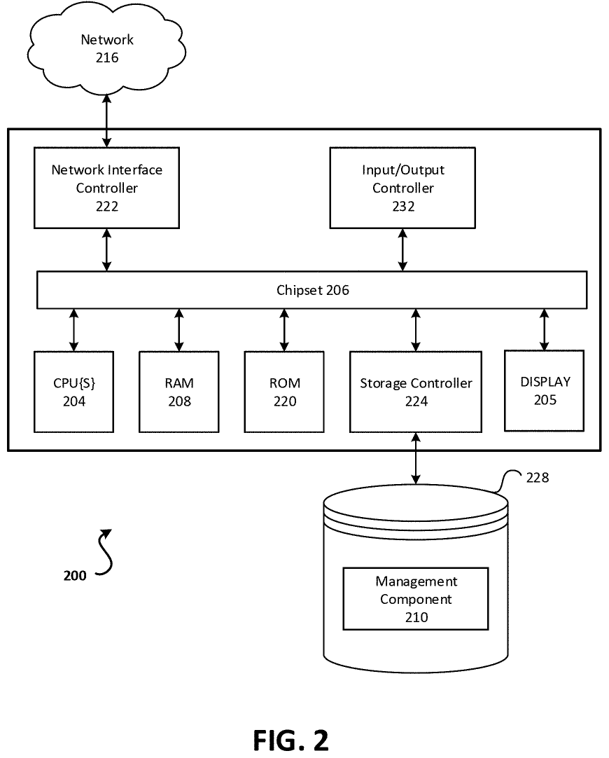

FIG. 2 depicts a computing device that may be used in various aspects, such as the servers, modules, and/or devices depicted in FIG. 1. With regard to the example architecture of FIG. 1, the electronic devices 100, 105, 110, 115 and 120 may each be implemented in an instance of a computing device 200 of FIG. 2. The computer architecture shown in FIG. 2 may illustrate a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 200 may include a baseboard, or “motherboard,” which is a printed circuit board to which a multitude of components or devices may be connected by way of a system bus or other electrical communication paths. One or more central processing units (CPUs) 204 may operate in conjunction with a chipset 206. The CPU(s) 204 may be standard programmable processors that perform arithmetic and logical operations necessary for the operation of the computing device 200.

The CPU(s) 204 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 204 may be augmented with or replaced by other processing units, such as GPU(s) 205. The GPU(s) 205 may comprise processing units specialized for but not necessarily limited to highly parallel computations, such as graphics and other visualization-related processing.

A chipset 206 may provide an interface between the CPU(s) 204 and the remainder of the components and devices on the baseboard. The chipset 206 may provide an interface to a random-access memory (RAM) 208 used as the main memory in the computing device 200. The chipset 206 may further provide an interface to a computer-readable storage medium, such as a read-only memory (ROM) 220 or non-volatile RAM (NVRAM) (not shown), for storing basic routines that may help to start up the computing device 200 and to transfer information between the various components and devices. ROM 220 or NVRAM may also store other software components necessary for the operation of the computing device 200 in accordance with the aspects described herein.

The computing device 200 may operate in a networked environment using logical connections to remote computing nodes and computer systems through local area network (LAN) 216. The chipset 206 may include functionality for providing network connectivity through a network interface controller (NIC) 222, such as a gigabit Ethernet adapter. A NIC 222 may be capable of connecting the computing device 200 to other computing nodes over a network 216. It should be appreciated that multiple NICs 222 may be present in the computing device 200, connecting the computing device to other types of networks and remote computer systems.

The computing device 200 may be connected to a mass storage device 228 that provides non-volatile storage for the computer. The mass storage device 228 may store system programs, application programs, other program modules, and data, which have been described in greater detail herein. The mass storage device 228 may be connected to the computing device 200 through a storage controller 224 connected to the chipset 206. The mass storage device 228 may consist of one or more physical storage units. A storage controller 224 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 200 may store data on a mass storage device 228 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 228 is characterized as primary or secondary storage and the like.

For example, the computing device 200 may store information to the mass storage device 228 by issuing instructions through a storage controller 224 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 200 may further read information from the mass storage device 228 by detecting the physical states or characteristics of one or more particular locations within the physical storage units.

In addition to the mass storage device 228 described above, the computing device 200 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 200.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 228 depicted in FIG. 2, may store an operating system utilized to control the operation of the computing device 200. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 228 may store other system or application programs and data utilized by the computing device 200.

The mass storage device 228 or other computer-readable storage media may also be encoded with computer-executable instructions, which, when loaded into the computing device 200, transforms the computing device from a general-purpose computing system into a special-purpose computer capable of implementing the aspects described herein. These computer-executable instructions transform the computing device 200 by specifying how the CPU(s) 204 transition between states, as described above. The computing device 200 may have access to computer-readable storage media storing computer-executable instructions, which, when executed by the computing device 200, may perform methods described herein.

A computing device, such as the computing device 200 depicted in FIG. 2, may also include an input/output controller 232 for receiving and processing input from a number of input devices, such as a keyboard, a mouse, a touchpad, a touch screen, an electronic stylus, or other type of input device. Similarly, an input/output controller 232 may provide output to a display 205, such as a computer monitor, a flat-panel display, a digital projector, a printer, a plotter, or other type of output device. It will be appreciated that the computing device 200 may not include all of the components shown in FIG. 2, may include other components that are not explicitly shown in FIG. 2, or may utilize an architecture completely different than that shown in FIG. 2.

As described herein, a computing device may be a physical computing device, such as the computing device 200 of FIG. 2. A computing node may also include a virtual machine host process and one or more virtual machine instances. Computer-executable instructions may be executed by the physical hardware of a computing device indirectly through interpretation and/or execution of instructions stored and executed in the context of a virtual machine.

### Exemplary System Operation

Exemplary embodiments of the present disclosure provide an efficient and reliable mechanism for managing requisitions and configuring options for the requisitions, via user interfaces, utilized by various entities, as described more fully below. For instance, one or more managers may coordinate with an organization (e.g., a company, institution, etc. (e.g., ZeroChaos™ or WorkforceLogiq™)) to customize a workflow for creating and managing requisitions with various access rights (e.g., view, add/update, and/or edit features, etc.) based on selected options from one or more interfaces generated by the organization. In an example embodiment, the one or more interfaces may be generated by a computing device (e.g., computing device 200) of the organization.

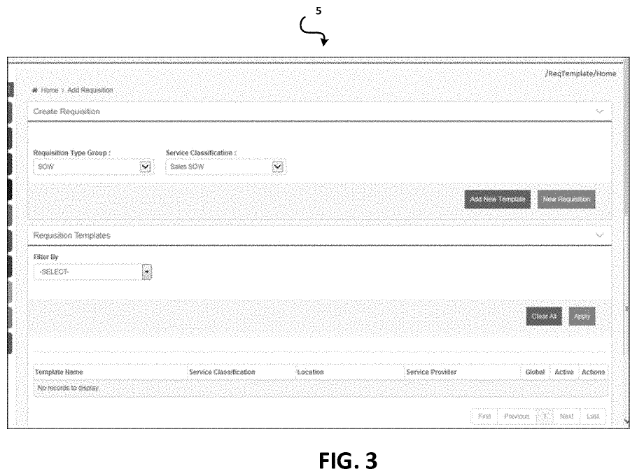

Referring now to FIG. 3, a diagram illustrating a create requisition interface according to an example embodiment is provided. In the example embodiment of FIG. 3, the computing device 200 may generate the create requisition user interface 5 during an initial requisition configuration process to configure one or more requisitions according to preferences of a client (e.g., a manager overseeing requisitions associated with RFPs, RFIs for submission to a service provider(s)). It should be pointed out that during the initial requisition configuration process, the create requisition user interface 5 may detect input of one or more selections to generate one or more types of requisitions (also referred to herein as requisition types or Statement of Work (SOW) requisition types). In this regard, for example, the create requisition user interface 5 may be utilized to detect selections of multiple requisition types according to preferences of a client.

For purposes of illustration and not of limitation, in one example, two requisition types may be customized, via the create requisition user interface 5 on behalf of a client. For instance, in this example, one of the requisition types may allow access rights for a service provider to build (e.g., select features associated with the requisition). On the other hand, the other of the two requisition types may not allow access to a service provider to build the requisition. As an example, for an information technology (IT) based requisition type, a service provider may be allowed access to help build out features of the associated requisition. However, for a construction-based requisition type, a service provider may not be allowed access to help build out features of the associated requisition. Any other suitable number of requisition types may be generated via the create requisition user interface 5 without departing from the spirit and scope of the present disclosure.

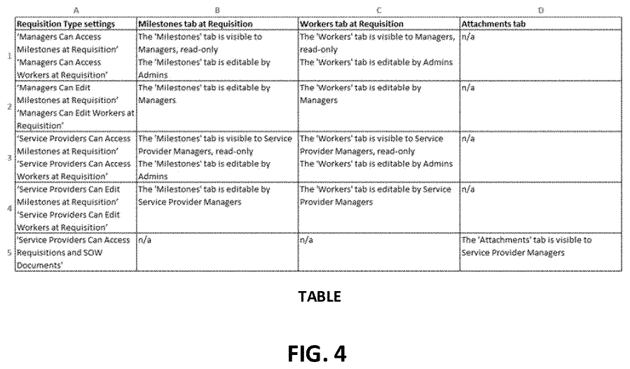

During the generation of a requisition type, one or more milestones to complete a task(s) associated with a service (e.g., phase one of construction for a building, phase one of a software development tool, etc.), worker data (e.g., number of workers and time worked to complete a milestone), budgeted requisition estimated cost and other features may be designated for the requisition associated with the service. In this regard, in an example embodiment, a user interface may be generated by the computing device 200 in which one or more flag features (also referred to herein as flags) may be chosen (e.g., corresponding to requisition type settings set to ‘on’) pertaining to access rights of the requisition. A non-exhaustive, and non-limiting, exemplary list of some of the flags and an associated effect on a requisition (e.g., a SOW requisition) that is associated with a requisition type where a requisition type switch in the VMS is set to ‘on’ or ‘true’. For example, depending on how the requisition type switch is set, the manager may or may not have read-only access to milestones when creating the requisition. Some other examples of flags based on requisition type settings are shown in the table of FIG. 4.

1. Managers Can Access Milestones at Requisition
a. A Requisition's Manager(s) has read-only access to Milestones

2. Managers Can Edit Milestones at Requisition
a. A Requisition's Manager(s) has edit access to Milestones

3. Managers Can Access Workers at Requisition
a. A Requisition's Manager(s) has read-only access to Workers

4. Managers Can Edit Workers at Requisition
a. A Requisition's Manager(s) has edit access to Workers

5. Service Providers Can Access Requisitions and Attachments
a. A Requisition's Service Provider has access to the Requisition's Details and Attachments

6. Service Providers Can Access Milestones at Requisition
a. A Requisition's Service Provider has read-only access to Milestones

7. Service Providers Can Edit Milestones at Requisition
a. A Requisition's Service Provider has edit access to Milestones

8. Service Providers Can Access Workers at Requisition
a. A Requisition's Service Provider has read-only access to Workers

9. Service Providers Can Edit Workers at Requisition
a. A Requisition's Service Provider has edit access to Workers

10. Require Milestones at Requisition
a. A Requisition's Milestones must be ‘Locked’ in order for the Requisition to be submitted for approval and for the Engagement to be created

11. Require Workers at Requisition
a. A Requisition's Workers must be ‘Locked’ in order for the Requisition to be submitted for approval and for the Engagement to be created

Based on various combinations of the flags being chosen, an exemplary non-exhaustive, and non-limiting, set of scenarios may be generated as set forth below.
Scenario 1—Service provider cannot see milestones or worker data. Managers can see the data, but MSP is responsible for all edits. For example, service providers can access milestones when creating or accessing a requisition via a requisition setting. The service providers can also access workers in the requisition when the requisition setting is set to ‘off’. Managers can access milestones in the requisition via the requisition setting. The managers can access workers in the requisition when the requisition setting is set to ‘on’.
Scenario 2—Service provider cannot see milestones or worker data. Both managers and MSP can edit the data. For example, service providers can access milestones when creating or accessing a requisition via a requisition setting. The service providers can also access workers in the requisition when the requisition setting is set to ‘off’. Managers can edit milestones in the requisition via the requisition setting. The managers can edit workers in the requisition when the requisition setting is set to ‘on’.
Scenario 3—Service provider and manager can see milestones and/or worker data, but cannot edit. MSP is responsible for all edits. For example, service providers can access milestones when creating or accessing a requisition via a requisition setting. The service providers can also access workers in the requisition when the requisition setting is set to ‘on’. Managers can access milestones in the requisition via the requisition setting. The managers can access workers in the requisition when the requisition setting is set to ‘on’.
Scenario 4—Service provider can see milestones and/or worker data, but cannot edit. Both Manager and MSP can edit the data. For example, service providers can access milestones when creating or accessing a requisition via a requisition setting. The service providers can also access workers in the requisition when the requisition setting is set to ‘on’. Managers can edit milestones in the requisition via the requisition setting. The managers can edit workers in the requisition when the requisition setting is set to ‘on’.
Scenario 5—All parties (e.g., manager, MSP, service provider) can both see and edit the data. For example, service providers can edit milestones when creating or accessing a requisition via a requisition setting. The service providers can also edit workers in the requisition when the requisition setting is set to ‘on’. Managers can edit milestones in the requisition via the requisition setting. The managers can edit workers in the requisition when the requisition setting is set to ‘on’.

In some exemplary embodiments, each scenario may be refined to allow the manager or the service provider to view or edit only a portion of the data (e.g., milestones or workers) by turning on/off the appropriate flag(s) associated with a requisition type before the requisition is created. Once the requisition has been created, the requisition can inherit settings from the requisition type.

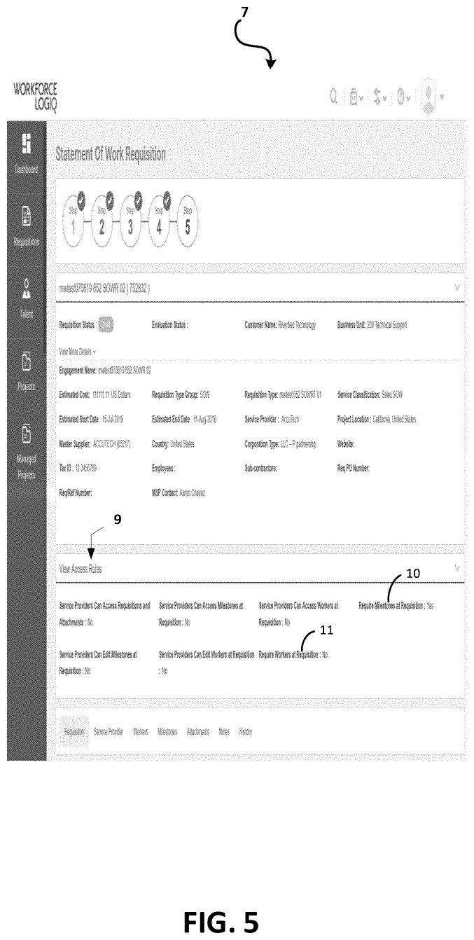

Referring now to FIG. 5, a diagram illustrating a requisition progress user interface is provided according to an exemplary embodiment. In the example of FIG. 5, the computing device 200 generated the requisition progress user interface 7. As shown in FIG. 5, in the View Access Rules section 9, the requisition progress user interface 7 detected input of a selection of flags to allow a service provider to access requisitions and attachments, access to milestones, access to workers and requires milestones in the requisition and workers in the requisition. On the other hand, flags were chosen such that service providers are not allowed to edit milestones in the requisition and not allowed to edit workers in the requisition.

For purposes of illustration and not of limitation, consider an example in which flag 10 (e.g., Require Milestones at Requisition) and flag 11 (e.g., Require Workers at Requisition) above are selected via a user interface associated with a corresponding requisition. In this example, presume that a create requisition user interface (e.g., create requisition user interface 5) is generated by a computing device (e.g., computing device 200) of an organization (e.g., ZeroChaos™ or WorkforceLogiq™) and is utilized by the organization to configure and tailor a workflow associated with the requisition per the desires of a client prior to creation of the requisition to a service provider(s). By selecting flags 10 and 11 this may require the locking of the milestones and/or workers associated with the requisition before approval (e.g., by an approving entity (e.g., a person designated for approval (e.g., a hiring manager, finance manager, procurement manager, etc.).

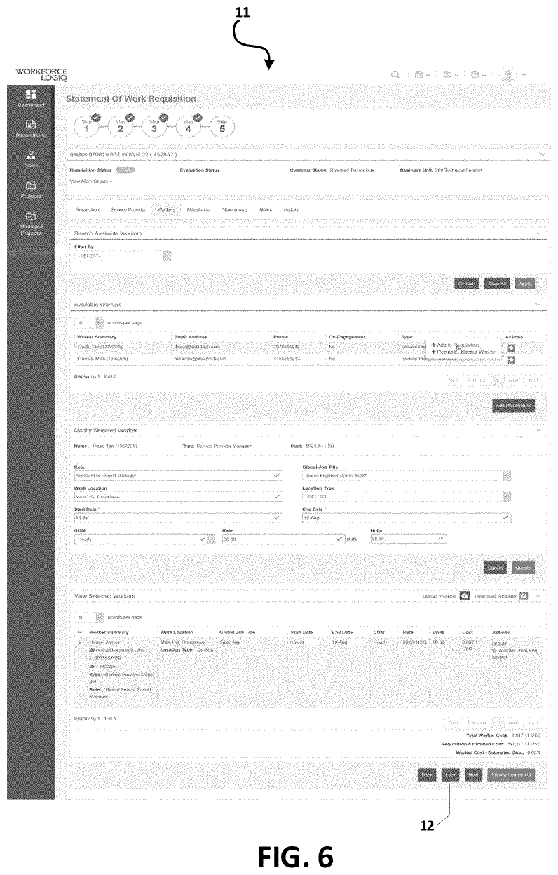

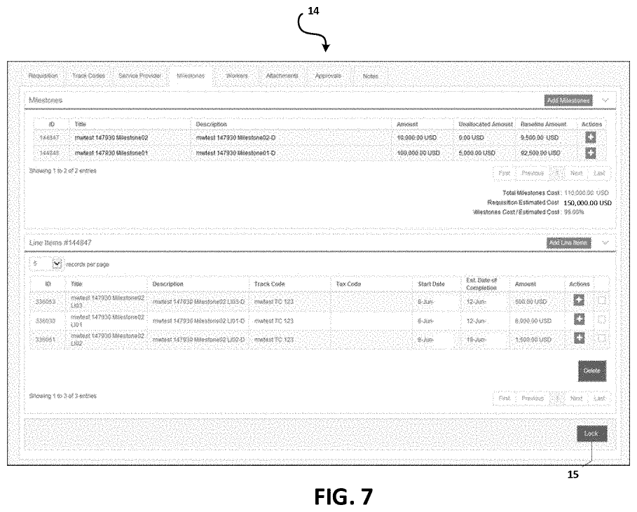

In an example embodiment, as soon as the manager selects a service provider(s) for the requisition (e.g., via the create requisition user interface 5), a user interface of the requisition is made available to the service provider. The service provider is automatically notified that the user interface of the requisition (also referred to herein as requisition user interface) is available. In one example embodiment, the service provider may be automatically notified (e.g., via electronic device 105) that the user interface of the requisition is available by email. Upon accessing the user interface of the requisition, the service provider may provide information in the user interface addressing inquiries (e.g., associated with workers, milestones, etc.) for the requisition. In this example, further presume that the service provider chooses a total cost (e.g., $8,887.11) associated with workers, as shown in the requisition user interface 11 of FIG. 6, and/or a total cost (e.g., $110,000) associated with the milestones, as shown in the requisition user interface 14 of FIG. 7, that is below the requisition's estimated cost (e.g., $111,111.11). The communication device (e.g., electronic device 105) of the service provider may send the user interface of the requisition, with the total cost, associated with the milestones and/or the total cost associated with workers, to the communication device (e.g., electronic device 100) of the manager for submission and approval.

Suppose that the estimated requisition cost was subsequently reduced to be less than the total costs associated with the milestones and/or the workers that the service provider sent to the communication device (e.g., electronic device 100) of the manager. In this regard, the MSP may unlock the milestones and/or worker total costs to allow the milestones and/or worker total costs to be edited (e.g., edited by the service provider (e.g., to allow the service provider to change the milestones and/or workers total cost to potentially submit total costs below the reduced estimated requisition cost). For example, in an instance in which the requisition's estimated cost was initially $100,000 and the milestones cost, of the service provider, totaled $95,000 and the milestones were initially locked (e.g., via tab 15) and then the requisition's estimated cost were subsequently reduced to $90,000, the MSP is allowed to unlock the milestones for the cost to be edited (e.g., by the service provider).

In response to detecting that the milestones and/or workers cost exceeds the requisition's estimated cost, a lock tab (e.g., lock tab 12 and/or lock tab 15) may be unlocked to allow editing; whenever a tab is unlocked, a notification (e.g., an email notification) is sent to a communication device of the relevant manager and/or service provider if the manager and/or service provider have edit rights according to the requisition type settings. This approach provides an advantage over prior techniques since there was previously not a manner by which to allow milestones/workers to be unlocked when their total cost exceeded the requisition's estimated cost. Previously, when an MSP had rights to lock/unlock milestones and/or workers tabs when creating a requisition, the MSP had the ability to control editability of the milestones and/or workers by managers and/or service provider when the managers and/or service provider have been granted edit rights. In other words, when a requisition is created, and the applicable requisition type settings inherited by the requisition allow the manager and/or service provider to edit a tab, a lock/unlock feature associated with the requisition empowers the MSP to deny/restore a manager's and service provider's ability to edit the requisition.

In an instance in which the updated milestones and worker costs is sent by the communication device (e.g., electronic device 105) of the service provider back to the communication device (e.g., electronic device 100) of the manager and is below the requisition's estimated cost (e.g., the approved budget), the MSP may lock (e.g., via a lock tab (e.g., lock tab 12, lock tab 15) of a user interface) the milestones and/or workers and validate the requisition for approval by the approving entity. The computing device 200 can additionally store and track the updated milestones and worker costs.

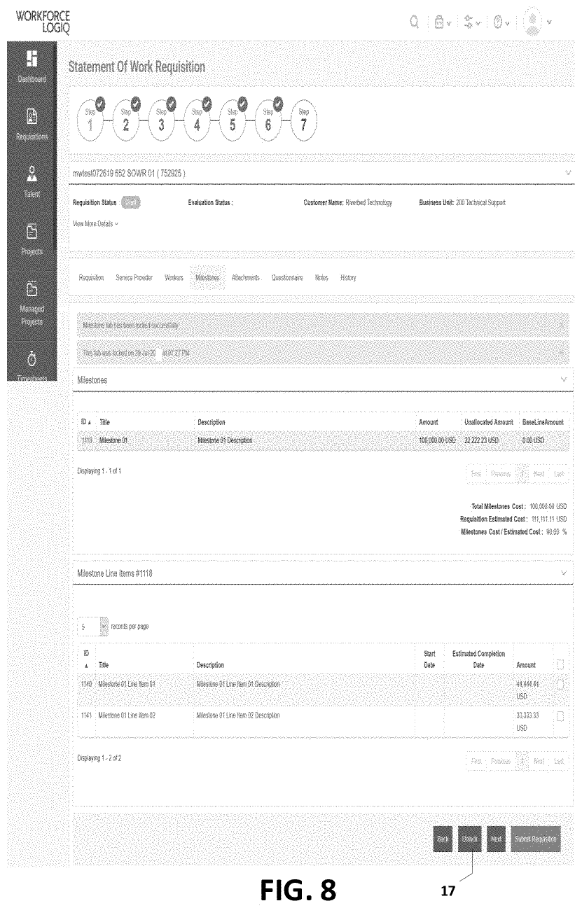

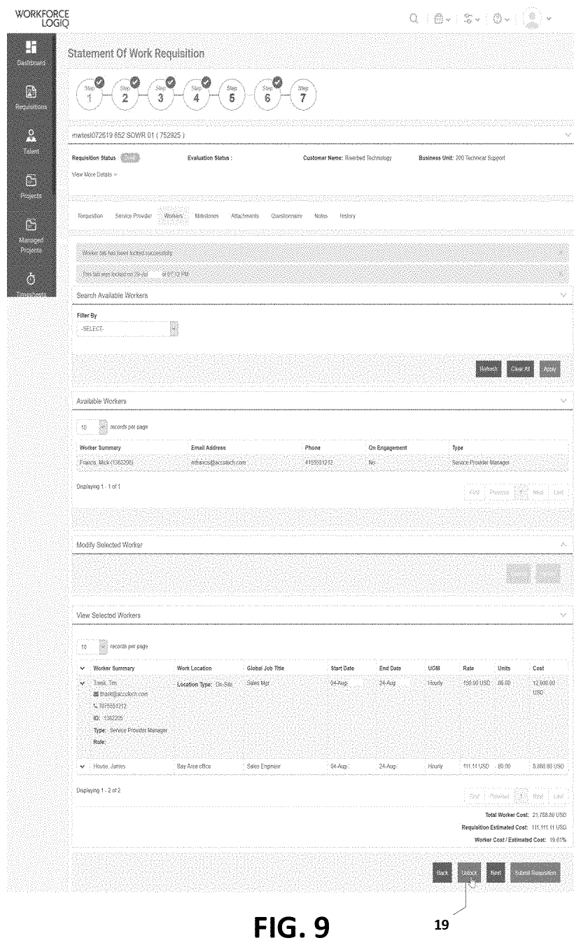

Upon locking the milestones by the MSP, the manager can receive confirmation that the milestones have been locked, as well as a time and date in which the milestones were locked (see FIG. 8). Upon locking the workers, the manager can receive confirmation that the workers have been locked, as well as a time and date in which the workers were locked (see FIG. 9). The manager may unlock (e.g., via an unlock tab (e.g., unlock tab 17 or unlock tab 19) of a user interface) to unlock milestones and/or workers should further updates to milestones and/or workers be required.

On the other hand, in an instance in which the updated milestones and/or worker costs are sent by the communication device (e.g., electronic device 105) of the service provider back to the communication device (e.g., electronic device 100) of the manager and remains above the requisition's estimated cost (e.g., the approved budget), as long as the milestones and/or workers tab is ‘unlocked’, it can be edited by managers and/or the service provider according to the requisition type settings that allows edit rights. As such, for example, even after an update of worker/milestone cost still being above an approved budget (e.g., above the requisition's estimated cost) a second time, the service provider may still have other opportunities to submit worker/milestones cost data under budget, so long as the milestones and/or workers tab is ‘unlocked’. In an example embodiment, MSP users may always have edit rights to edit milestones and/or workers data.

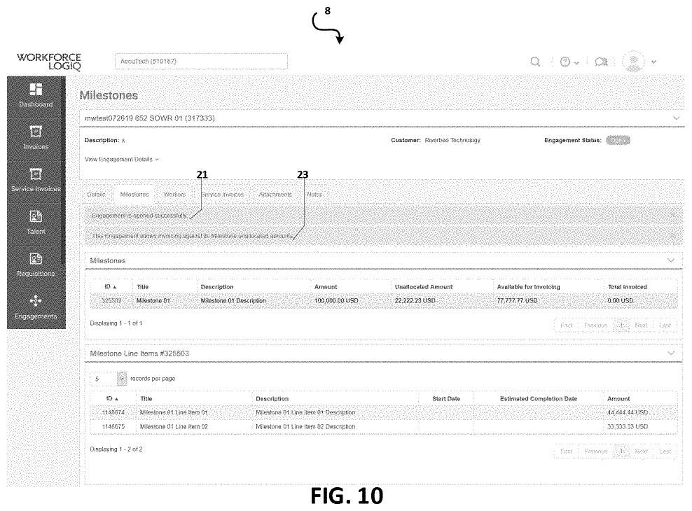

Validation of the requisition for approval by the approving entity can entail obtaining an electronic signature (e.g., via DocuSign™ or any other software that can be used to obtain an electronic signature), when signatures are required. Upon validation of the requisition by the approving entity, in user interface 8, the computing device 200 can generate an engagement based on the agreed upon milestones and/or workers, as well as any other criteria agreed to in the requisition (see FIG. 10). For example, when signatures are required, the engagement cannot be opened for invoicing until both the manager and service provider have electronically signed the document (e.g., a SOW) through DocuSign. There can be an additional signature setting for the requisition type that requires a third signature from an MSP (e.g., an administration (Admin) user).

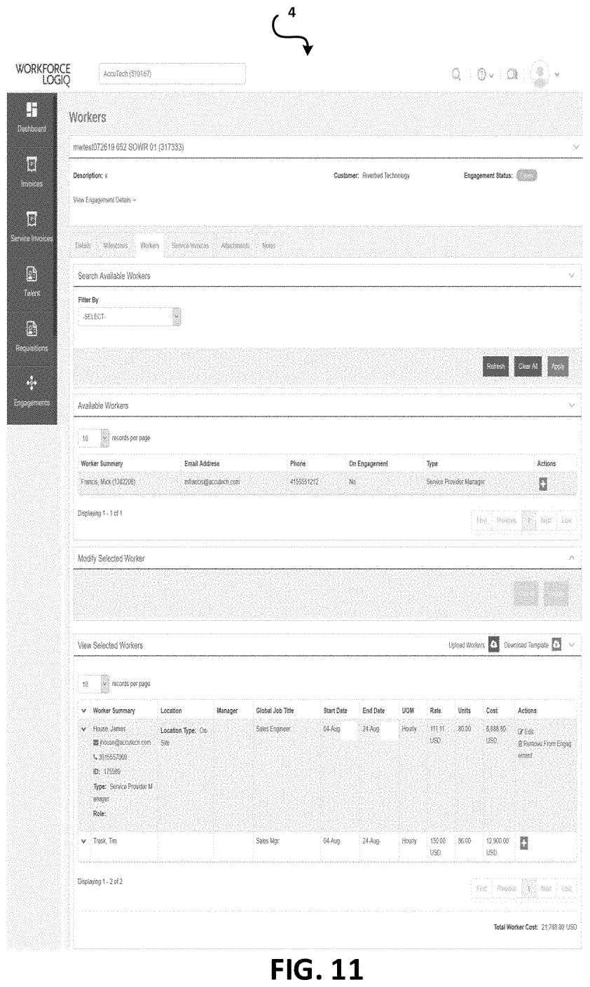

The manager and service provider, which are parties to the requisition, can receive confirmation at tab 21 that an engagement based on the validated requisition has been opened successfully. The service provide can also receive details tab 23 regarding invoicing against milestones within the validated requisition. The manager and service provider can also receive and/or access engagement details related to the validated requisition (e.g., user interface 4 of FIG. 11).

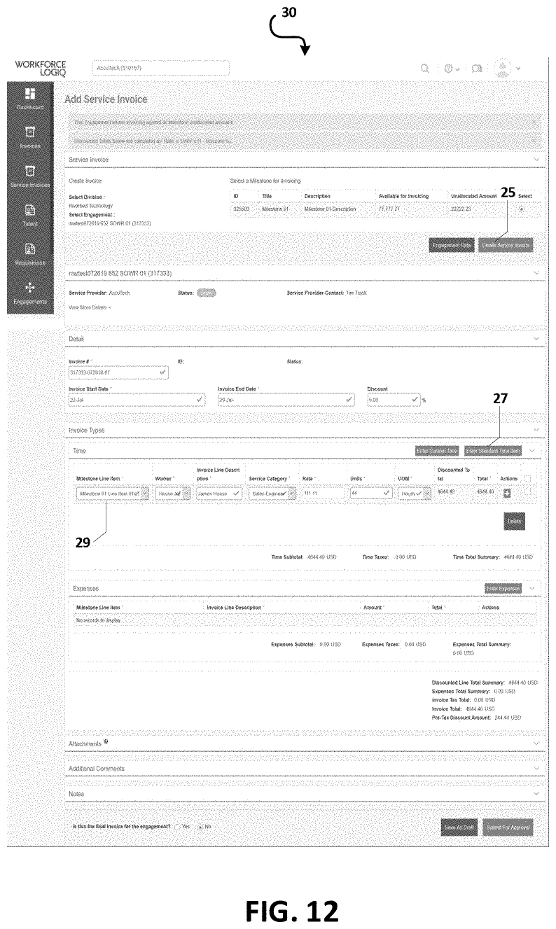

FIG. 12 illustrates an exemplary user interface 30 for invoicing according to one or more embodiments. As work for a given task(s) associated with a milestone is completed, at tab 25, the service provider can create an invoice for the work associated with a given milestone/milestone line item (tab 29). When creating the invoice, at tab 27 the service provider can indicate time for a worker assigned to complete or assist with a given milestone (tab 29).

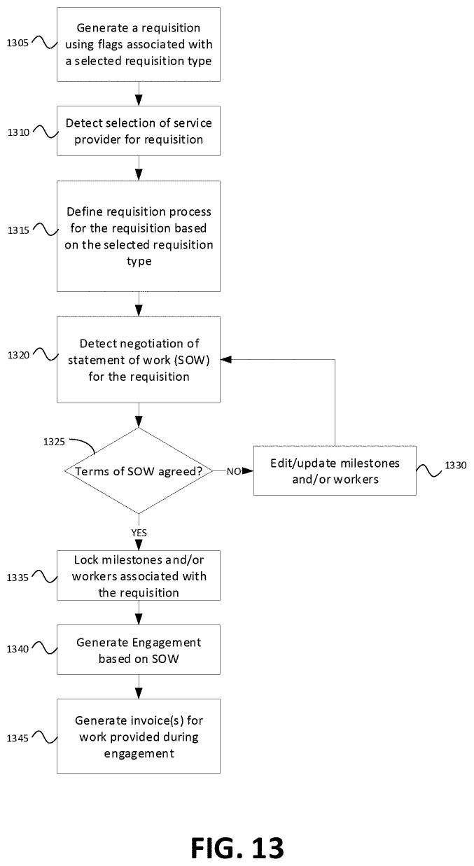

FIG. 13 is an exemplary flow diagram illustrating a method for managing requisitions according to one or more embodiments. At block 1305, a purchasing contact (manager) can utilize a computing device (e.g., computing device 200) to generate a requisition using one or more flags associated with a selected requisition type via a user interface. At block 1310, the manager can select a service provider (e.g., a preferred vendor for work associated with the requisition) for association with the requisition via a user interface. At block 1315, a requisition process (e.g., milestone and/or worker creation) for the requisition can be defined based on the selected requisition type. For example, one or more milestones and/or one or more items of worker data of the requisition can be defined and/or updated via a user interface. At block 1320, a statement of work (SOW) associated with the requisition is negotiated between the manager and the service provider. For example, the manager and the service provider can negotiate milestones and/or workers to be associated with the SOW. At block 1325, the computing device can determine whether the terms of the SOW have been agreed to by the manager and the service provider. For example, both the manager and the service provider can input signed copies of the SOW to the computing device via a user interface.

If the terms of the SOW have not been agreed to by the manager and the service provider, the method proceeds to block 1330 where the manager and/or the service provider may edit/update terms of the SOW (e.g., milestones and/or workers, etc.), via a user interface, before returning to block 1320. If the terms of the SOW have been agreed to by the manager and the service provider, the method proceeds to block 1335 where the managed service provider (MSP) can lock the requisition to prevent additional changes via a user interface.

At block 1340, the computing device can generate an engagement based on the SOW to outline the work to be conducted under the SOW. At block 1345, the computing device can receive invoices, via a user interface, from the service provider relating to work performed by the client during an engagement.

Accordingly, methods, apparatuses and systems disclosed herein allow parties to a requisition to create a requisition, negotiate the requisition, accept the requisition, manage responsibilities associated with the requisition, update the requisition, finalize the requisition to generate an engagement and invoice a client for an engagement based on milestones associated with the engagement. Once a requisition is approved by the client, the engagement may be opened, which renders the requisition obsolete. Accordingly, the requisition is retired, and the engagement controls the (one or more) milestones, workers and invoicing. The methods, apparatuses and systems disclosed herein allow for convenient review of the SOW for parties to the SOW and records every action and change during negotiations of terms related to a SOW by the business and service provider, as well as subsequent changes/updates to performance of work under the SOW.

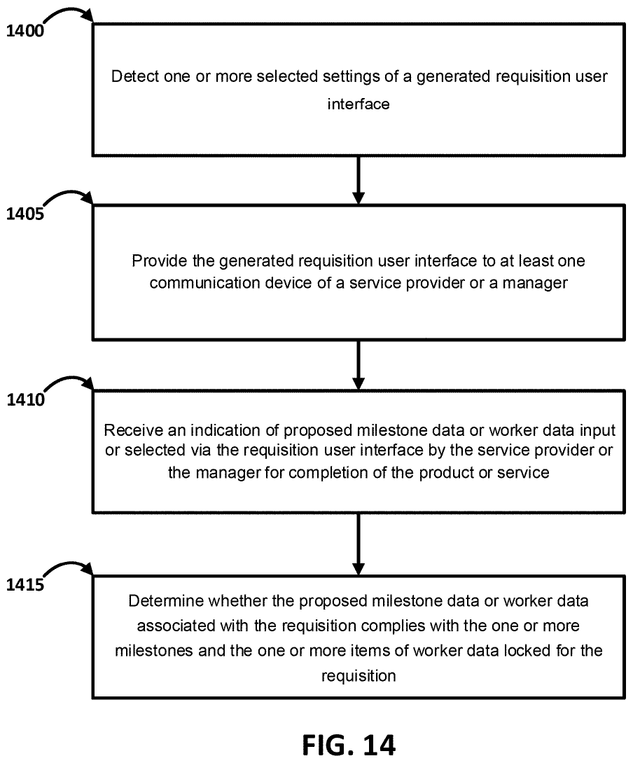

FIG. 14 is an exemplary flow diagram illustrating another example method for managing requisitions via one or more graphical user interfaces according to another exemplary embodiment. At operation 1400, an apparatus (e.g., electronic device 105) may detect one or more selected settings (e.g. one or more requisition flags) of a generated requisition user interface. The selected settings may denote that one or more milestones and one or more items of worker data, associated with a respective requisition (e.g., a statement of work requisition) for completion of a product or service, are to be locked for the requisition to be approved. In some example embodiments, the milestones and the one or more items of worker data may be locked via a locked tab (e.g., lock tab 12, lock tab 15) of a user interface.

At operation 1405, an apparatus (e.g., electronic device 105) may provide the generated requisition user interface (e.g., requisition user interface 11) to at least one communication device (e.g., electronic device 100, electronic device 110, etc.) of a service provider and/or a manager. At operation 1410, an apparatus (e.g., electronic device 105) may receive an indication of proposed milestone data or worker data input or selected via the requisition user interface by the service provider or the manager for completion of the product or service (e.g., phase one of construction for a building, phase one of a software development tool, any other suitable task for completion of a product or service) associated with the requisition.

At operation 1415, an apparatus (e.g., electronic device 105) may determine whether the proposed milestone data or worker data associated with the requisition complies with the one or more milestones and the one or more items of worker data locked for the requisition. In some example embodiments, an apparatus (e.g., electronic device 105) may determine whether the proposed milestone data or worker data associated with the requisition complies by determining whether a cost (e.g., worker cost $8,887.11 and/or milestone cost $110,000.00) associated with the proposed milestone data or worker data for completion of the product or service is below a designated requisition estimated cost (e.g., requisition estimated cost of $150,000.00). The apparatus (e.g., electronic device 105) may generate an engagement including an agreement for the service provider to complete the product or service in response to determining that the cost is below the designated requisition estimate cost and in response to selecting the service provider for completion of the product or service.

In some other exemplary embodiments, in response to determining that the cost (e.g., worker cost $8,887.11 and/or milestone cost $110,000.00) exceeds the requisition estimate cost (e.g., $111,111.11), the apparatus (e.g., electronic device 105) may enable unlocking, via the requisition user interface (e.g., via unlock tab 19 of FIG. 9), of the one or more milestones and the one or more items of worker data to enable the service provider to input, via the requisition user interface, updated proposed milestone data, worker data and a proposed cost (e.g., 105,000.00) that may be below the designated requisition estimate cost (e.g., $150,000.00).

A user interface is provided herein that facilitates creating, processing and invoicing against a requisition by utilizing milestones tabs, worker tabs and line items tab, which can be added to the requisition. The interface includes an “accept” feature that allows both a supplier and a purchasing contact to accept/lock the milestones and worker rates.

Configuration settings which can be used with the requisition to allow read-only or edit access to milestones and/or workers tabs by managers and service providers, allow upload/download access to an attachments tab by service providers, allows an MSP to lock milestones and/or workers tabs to a non-editable version when the milestones and workers are turned on, allow a requisition to be submitted for approval once the milestones and/or workers have been locked, and generate an engagement based on the submitted requisition.

Other aspects disclosed herein is that managers can access milestones and workers based on requisition flags that were inherited from the requisition's requisition type at an instance when the requisition was created. When a flag associated with the requisition is ‘true’, managers that have access to the requisition may have access to a read-only milestones tab and/or workers tab and when a flag associated with the requisition is ‘false’, the milestones tab and/or workers tab may be hidden from managers viewing the requisition.

Other aspects disclosed herein is that managers can edit milestones and workers based on requisition flags that were inherited from the requisition's requisition type at an instance when the requisition was created. When a flag associated with the requisition is ‘true’, the milestones tab and/or workers tab within the requisition may be editable by managers and when a flag associated with the requisition is ‘false’, the milestones tab and/or workers tab within the requisition may not be editable by managers.

Other aspects disclosed herein is that service providers can access requisitions and attachments using requisition flags. When a flag associated with the requisition is ‘true’, service provider will have access to an ‘attachments’ tab within the requisition and may be able to upload and download files for association with the requisition.

Other aspects disclosed herein is that service providers can access milestones and workers using requisition flags. When a flag associated with the requisition is ‘true’, service providers who have access to the requisition will have access to a read-only milestones tab and/or workers tab at the requisition and when a flag associated with the requisition is ‘false’, the milestones tab and/or workers tab at the requisition will be hidden from service providers.

Other aspects disclosed herein is that service providers can edit milestones and workers using requisition flags. When a flag associated with the requisition is true', the milestones tab and/or workers tab at the requisition will be editable by service providers and when a flag associated with the requisition is ‘false’, the milestones tab and/or workers tab at the requisition will not be editable by service providers.

Other aspects disclosed herein is that a requisition's ‘selected’ service provider may have restricted access to the requisition whenever any one of the following is true: (1) when a requisitions and attachments flag inherited by the requisition is ‘true’ and the requisition is in an active status or (2) the requisition is pending a compliance evaluation (e.g., a 1099 compliance evaluation).

Moreover, methods and systems disclosed herein can define one or more workflows for their SOW requisitions. For example, through pre-configured settings, a client/manager can create an SOW requisition where the selected service provider and client manager can participate in defining the requisition's ‘milestones’ and ‘milestone line items’ against which the service provider will submit their invoices, and create another SOW requisition when the service provider and/or client manager are not able to affect the requisition's milestones and milestone line items so that the service provider's invoice options are controlled entirely by an MSP.

Similarly, through pre-configured settings, the customer can create a SOW requisition where the selected service provider and client manager may participate in defining workers whose time the service provider will be invoiced to the client and another SOW requisition where workers are not identified, and the service provider will not invoice the client for worker time. To further control milestones and workers for a requisition, pre-configured settings can enable the MSP to lock applicable fields once the applicable fields are complete and ratified. Accordingly, the configurability of the methods, apparatuses and systems described herein may provide a competitive advantage by tailoring graphical requisition user interfaces based on the needs of entities associated with a statement of work.

Some other alternative exemplary embodiments may provide an apparatus comprising a processor and a memory, the memory storing computer-executable instructions which when executed by the processor, cause the apparatus to perform operations comprising: detecting one or more selected settings of a generated requisition user interface, the selected settings denoting that one or more milestones and one or more items of worker data, associated with a respective requisition for completion of a product or service, are to be locked for the requisition to be approved; providing the generated requisition user interface to at least one communication device of a service provider or a manager; receiving an indication of proposed milestone data or worker data input or selected via the requisition user interface by the service provider or the manager for completion of the product or service associated with the requisition; and determining whether the proposed milestone data or worker data associated with the requisition complies with the one or more milestones and the one or more items of worker data locked for the requisition.

Some other alternative exemplary embodiments may provide an apparatus having instructions when executed by the processor, further causes the apparatus to perform operations comprising determining whether the proposed milestone data or worker data associated with the requisition complies by determining whether a cost associated with the proposed milestone data or worker data for completion of the product or service is below a designated requisition estimate cost.

Some other alternative exemplary embodiments may provide an apparatus having instructions when executed by the processor further causes the apparatus to perform operations comprising generating an engagement comprising an agreement for the service provider to complete the product or service in response to determining that the cost is below the designated requisition estimate cost.

Some other alternative exemplary embodiments may provide an apparatus having instructions when executed by the processor further causes the apparatus to perform operations comprising in response to determining that the costs exceed the requisition estimate cost, enabling unlocking, via the requisition user interface, of the one or more milestones and the one or more items of worker data to enable the service provider to input, via the requisition user interface, updated proposed milestone data, worker data and a proposed cost that is below the designated requisition estimate cost.

Some other alternative exemplary embodiments may provide an apparatus having instructions when executed by the processor further causes the apparatus to perform operations comprising detecting, via the requisition user interface, negotiations of the one or more milestones and the one or more items of worker data associated with the requisition by the service provider and the manager.

Some other alternative exemplary embodiments may provide an apparatus in which the settings are associated with one or more flags and wherein the instructions when executed by the processor further causes the apparatus to perform operations comprising determining a state of at least one of the flags associated with the one or more milestones; and displaying the one or more milestones via the requisition user interface in response to the state of the at least one flag being set to on.

Some other alternative exemplary embodiments may provide an apparatus having instructions when executed by the processor further causes the apparatus to perform operations comprising detecting updates to the one or more milestones and the one or more items of worker data.

Some other alternative exemplary embodiments may provide an apparatus in which the requisition user interface is generated in response to detection of a selection within a user interface of a requisition type from a plurality of types of requisitions.

### CONCLUSION

Many modifications and other embodiments of the present disclosures set forth herein will come to mind to one skilled in the art to which these present disclosures pertain having the benefit of the teachings presented in the foregoing descriptions and the associated drawings. Therefore, it is to be understood that the present disclosures are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed:

1. An apparatus comprising a processor and a memory, the memory storing computer-executable instructions which when executed by the processor, cause the apparatus to perform operations comprising:
generating, via a user interface, a requisition for a product or service, wherein the requisition comprises one or more milestones and/or one or more items of worker data;
detecting input from a service provider and/or manager, wherein the input comprises updating the one or more milestones and/or one or more items of worker data of the requisition;
receiving, via the user interface, an input from the service provider or manager denoting an agreement to the one or more milestones and one or more items of worker data associated with the requisition;
in response to an agreement to the one or more milestones and one or more items of worker data associated with the requisition, receiving, via the user interface, a request from the manager to lock the requisition;
in response locking the requisition, generating an engagement based on the requisition; and
invoicing, via the user interface, a client for work provided by the service provider according to the one or more milestones.

2. The apparatus of claim 1, wherein the instructions when executed further causes the apparatus to perform operations comprising:
providing a requisition user interface to a communication device of at least one service provider to enable the requisition user interface to detect input from the service provider of proposed milestone data and worker data and a corresponding cost for completion of the product or service associated with the requisition; and
receiving the input from the service provider and determining whether the cost exceeds an approved requisition estimated cost.

3. The apparatus of claim 2, wherein the instructions when executed further causes the apparatus to perform operations comprising:
determining that the approved requisition estimated cost was subsequently reduced to obtain a subsequent requisition estimated cost that is less than the total costs associated with the cost for completion of the product or service associated with the requisition and in response enabling a managed service provider (MSP) to unlock the milestones and the worker data to allow the milestones and the worker data to be edited.

4. The apparatus of claim 3, wherein the instructions when executed further causes the apparatus to perform operations comprising:
generating an interface for provision to the communication device of the service provider, prompting the service provider to update the milestone data and the worker data and a corresponding new cost, wherein the new cost is below the subsequent requisition estimated cost.

5. The apparatus of claim 1, wherein negotiations of the one or more milestones and/or one or more workers associated with the requisition by the service provider and manager is conducted via the user interface.

6. The apparatus of claim 1, wherein the instructions when executed further causes the apparatus to perform operations comprising:
determining a flag state of a flag associated with the one or more milestones;
displaying the one or more milestones via the user interface in response to the flag state of the flag being set to true; and
not displaying the one or more milestones via the user interface in response to the flag state of the flag being set to false.

7. The apparatus of claim 1, wherein the instructions when executed further causes the apparatus to perform operations comprising:
determining a flag state of a flag associated with the one or more items of worker data;
displaying the one or more items of worker data via the user interface in response to the flag state of the flag being set to true; and
not displaying the one or more items of worker data via the user interface in response to the flag state of the flag being set to false.

8. The apparatus of claim 1, wherein the instructions when executed further causes the apparatus to perform operations comprising tracking updates to the one or more milestones and one or more items of worker data.

9. The apparatus of claim 1, wherein the instructions when executed further causes the apparatus to perform operations comprising storing a signed version of the requisition.

10. The apparatus of claim 1, wherein the requisition is generated in response to receiving a selection of a requisition type from a plurality of types of requisitions from the manager.

11. A method for managing requisitions comprising:
generating, via a user interface, a requisition for a product or service, wherein the requisition comprises one or more milestones and/or one or more items of worker data;
detecting, via a processor, input from a service provider and/or manager, wherein the input comprises updating the one or more milestones and/or one or more items of worker data of the requisition;
receiving, via the user interface, an input from the service provider or manager denoting an agreement to the one or more milestones and one or more items of worker data associated with the requisition;
in response to an agreement to the one or more milestones and one or more items of worker data associated with the requisition, receiving, via the user interface, a request to lock the requisition;
in response to locking the requisition, generating, via the processor, an engagement based on the requisition; and
invoicing, via the user interface, a client for work provided by the service provider according to the one or more milestones.

12. The method of claim 11, further comprising:
providing a requisition user interface to a communication device of at least one service provider to enable the requisition user interface to detect input from the service provider of proposed milestone data and worker data and a corresponding cost for completion of the product or service associated with the requisition; and
receiving the input from the service provider and determining whether the cost exceeds an approved requisition estimated cost.

13. The method of claim 12, further comprising:
determining that the approved requisition estimated cost was subsequently reduced to obtain a subsequent requisition estimated cost that is less than the total costs associated with the cost for completion of the product or service associated with the requisition and in response, unlocking the milestones and the worker data to allow the milestones and the worker data to be edited.

14. The method of claim 13, further comprising:
generating an interface for provision to the communication device of the service provider, prompting the service provider to update the milestone data and the worker data and a corresponding new cost, wherein the new cost is below the subsequent requisition estimated cost.

15. The method of claim 11, wherein negotiations of the one or more milestones and/or one or more workers associated with the requisition by the service provider and manager is conducted via the user interface.

16. The method of claim 11, further comprising:
determining a flag state of a flag associated with the one or more milestones;
displaying the one or more milestones via the user interface in response to the flag state of the flag being set to true; and
not displaying the one or more milestones via the user interface in response to the flag state of the flag being set to false.

17. The method of claim 11, further comprising:
determining a flag state of a flag associated with the one or more items of worker data;
displaying the one or more items of worker data via the user interface in response to the flag state of the flag being set to true; and
not displaying the one or more items of worker data via the user interface in response to the flag state of the flag being set to false.

18. The method of claim 11, further comprising tracking updates to the one or more milestones and one or more items of worker data.

19. The method of claim 11, further comprising storing a signed version of the requisition.

20. The method of claim 11, wherein the requisition is generated in response to receiving a selection of a requisition type from a plurality of types of requisitions from the manager.
